(19) United States
(12) Patent Application Publication
(10) Pub. No.: US 2016/0248370 A1
(43) Pub. Date: Aug. 25, 2016

(54) Pedestrian Accommodation System And Network

(71) Applicant: Viktor Nelepa, Dubai (AE)

(72) Inventor: Viktor Nelepa, Dubai (AE)

(21) Appl. No.: 14/629,726

(22) Filed: Feb. 24, 2015

(51) Int. Cl. H02S 20/25

(52) U.S. Cl. CPC H02S 20/25

(57) ABSTRACT

There is provided a pedestrian accommodation system comprising a solar power system comprising at least one photovoltaic solar panel module; a roof structure adapted to receive said at least one photovoltaic solar panel module; a mounting structure adapted to support the roof structure to the ground; an electronic kiosk adapted to be electrically coupled to said solar power system and to be located under the roof structure; wherein said the roof structure is adapted to form a shelter zone protecting users from rain or sunlight while using the kiosk. There is further provided a network a plurality of pedestrian accommodation systems; energy storage device comprising at least one battery adapted to be connected to the plurality of pedestrian accommodation systems for storing energy generated by their respective solar power systems; an electrical distribution system adapted to be connected to the plurality of pedestrian accommodation systems for monitoring energy consumption needs thereof and for distributing electrical energy thereto from the at least one battery based on said needs.

### FIELD OF THE INVENTION

The present invention relates to solar-powered kiosks, pedestrian shelters and illumination systems, and more particularly to a pedestrian accommodation system and network comprising combined multi-functional solar-powered kiosks and shelters.

### BACKGROUND OF THE INVENTION

Kiosks are widely known machines in public places having pedestrian traffic and have been used for selling railroad tickets and the like in locations of this type. Electronic kiosks including computer operated and interactive kiosks are also known in the art which usually have computer terminals employing custom kiosk software designed to conduct defined functions while preventing users from accessing system functions. Some computer kiosks provide a free, informational public service, while others serve a commercial purpose such as kiosks installed in shopping malls. Touch screens, trackballs, computer keyboards, and pushbuttons are all typical input devices for interactive computer kiosk. Touch screen kiosks are commercially used as industrial appliances for improving efficiency and service to pedestrians. Their uses are varied from refrigerators to airports, health clubs, movie theaters and libraries.

Pedestrian shelters are known in the prior art generally for bus/train stops. Such shelters involve the modular construction or not with lateral walls and rear wall with a cover for the same. Walls of the shelters are some time provided with elements for exhibition of advertising and/or informative material. Nowadays and in particular in places of quite hot climate with outside temperatures near 40° C., or even higher, it is already known climatization systems through atomization of water. Such systems provide thermal comfort in open atmospheres similar to air-conditioned for closed atmospheres.

Electronic kiosks suggested in the prior art are normally installed in urban areas where electrical power is available for powering such kiosks. In addition, kiosks installed in open areas (such as streets) do not provide resting facilities for allowing pedestrians to rest and shelter while using services provided by these kiosks. From another side, pedestrian shelters proposed in the prior art do not provide electronic services of general public utility which are of an increasing need to the public nowadays due to the increasing independency to online services and use of mobile devices. When these traditional shelters have illumination devices, these are generally electrically powered which also require to be in proximity to electrical installations.

One of the problems of the traditional kiosks and shelters is that they do not provide a one stop station to pedestrians with resting/sheltering facilities during their journey all in having access to electronic services of general utility to them. Another problem is that traditional kiosks and traditional shelters are electrically powered thus complicated and expensive in terms of operation and limited to areas in proximity of electrical distribution networks. This is when there are increasing concerns over air pollution, climate change and the shortage of natural resources making photovoltaic an increasingly attractive energy supply technology and countries all over the world have increased interest in solar powered devices.

### SUMMARY OF THE INVENTION

It is therefore an object of the present invention to provide a pedestrian accommodation system and network providing pedestrian users with a combined shelter and kiosk facilities.

As a first aspect of the invention, there is provided a pedestrian accommodation system comprising:
a solar power system comprising at least one photovoltaic solar panel module;
a roof structure adapted to receive the at least one photovoltaic solar panel module
a mounting structure adapted to support the roof structure to the ground;
an electronic kiosk adapted to be electrically coupled to the solar power system and to be located under the roof structure;
wherein the roof structure is adapted to form a shelter zone protecting users from rain or sunlight while using the kiosk.

In an embodiment of the invention, the system further comprises an illumination device electrically coupled to the solar power system, the illumination device being adapted to project light within the shelter zone.

In an embodiment of the invention, the illumination device is adapted to be located within the roof structure.

In an embodiment of the invention, the roof structure has foliage like structure.

In an embodiment of the invention, the roof structure comprises a plurality of roof sections each one having a leaf like structure.

In an embodiment of the invention, the least one photovoltaic solar panel module comprises a plurality of photovoltaic solar panel modules each one having a leaf like structure, the plurality of photovoltaic solar panel modules forming the plurality of roof sections.

In an embodiment of the invention, the photovoltaic solar panel modules form a top portion of the roof structure adapted to be directed upwardly for exposure to the sun, and wherein the illumination device form a bottom portion of the roof structure adapted to provide light downwardly towards the ground for users within the shelter zone.

In an embodiment of the invention, the system further comprises a fan comprising a rotor and radial-axial rotor blades adapted to be located within the roof structure and to be electrically connected to the solar power system.

In an embodiment of the invention, the roof sections are adapted to be in a blade like structure forming the radial-axial rotor blades.

In an embodiment of the invention, the mounting structure comprises a housing adapted to house the electronic kiosk.

In an embodiment of the invention, the electronic kiosk comprises a display and wherein the housing comprises an opening adapted to enable user access to the display.

In an embodiment of the invention, the display is an interactive display enabling user access to electronic services.

In an embodiment of the invention, the display is an advertisement display.

In an embodiment of the invention, the electronic kiosk comprises battery chargers for enabling users to charge their mobile devices, and wherein the housing comprising openings adapted to enable user access to the battery chargers.

In an embodiment of the invention, the mounting support is in the form of a stem.

In an embodiment of the invention, the system further comprises a bench adapted to be located under the roof structure within the shelter zone.

In an embodiment of the invention, the bench is adapted to be positioned in such a manner to provide user access to the display while sitting on the bench.

In an embodiment of the invention, the system further comprises energy generating floor tiles for transforming pedestrian movements into electrical energy, the energy tiles being adapted to be electrically connected to the electronic kiosk and to the illumination device.

In an embodiment of the invention, the energy tiles are located on a pedestrian pass way in proximity of the mounting structure, the energy tiles comprising underground electrical cables adapted to extend between the energy tiles and the kiosk.

In an embodiment of the invention, the system further comprises an electrical combiner for combining electrical energy originating from the solar system and the energy tiles.

In an embodiment of the invention, the system further comprises a battery for storing the electrical energy generated using the solar system and the energy tiles.

In an embodiment of the invention, the roof structure is in the form of foliage, the support structure is in the form of a stem and the combination of the roof structure and the support structure is in the form of a palm tree.

In an embodiment of the invention, the kiosk comprises a computer terminal and an interactive display providing a range of electronic services to users.

In an embodiment of the invention, the kiosk is adapted to provide multi-functional services to the users.

In an embodiment of the invention, the kiosk comprises a wireless access point adapted to generate a hotspot within the shelter zone to enable users to connect to the Internet using their mobile devices within the zone.

In an embodiment of the invention, the kiosk comprises a public phone for enabling users to perform private calls, video calls and/or emergency calls using the accumulated energy.

In an embodiment of the invention, the pubic phone is an IP telephone.

In an embodiment of the invention, the kiosk is adapted to provide users with a list of stores and respective contact information located within a predefined geographical zone from the kiosk.

In an embodiment of the invention, the kiosk comprises a navigation system adapted to orient the users towards a desired location within a predefined geographical zone from the kiosk.

In an embodiment of the invention, the desired location comprises at least one of another kiosk, a store, a police station, a hospital, and a restaurant.

In an embodiment of the invention, the system further comprises a vending machine operationally coupled to the kiosk for enabling users to order items available at the vending machine.

In an embodiment of the invention, the system further comprises an IP camera operationally coupled to the kiosk for enabling users to use the IP camera for taking pictures and/or video streaming.

In an embodiment of the invention, the system further comprises a medical device operationally coupled to the kiosk for enabling users to perform basic medical measurements comprising at least one of a pressure, pulse and body fat measurement.

In an embodiment of the invention, the kiosk comprises a computer terminal adapted to be connected to a remote server via a data network.

In an embodiment of the invention, the remote server is adapted to remotely access, configure and operate the kiosk through a data network connected to the computer terminal.

In an embodiment of the invention, the remote server is part of a control center.

As a further aspect of the invention, there is provided a pedestrian accommodation network comprising:
a plurality of pedestrian accommodation systems according to any one of the system embodiments described above;
energy storage device comprising at least one battery adapted to be connected to the plurality of pedestrian accommodation systems for storing energy generated by their respective solar power systems;
an electrical distribution system adapted to be connected to the plurality of pedestrian accommodation systems for monitoring energy consumption needs thereof and for distributing electrical energy thereto from the at least one battery based on the needs.

In an embodiment of the invention, the network further comprises:
energy tiles adapted to be mounted on pedestrian pass ways and to be connected to the energy storage device for converting kinetic energy generated by pedestrians into electrical energy and for storing the energy inside the at least one battery.

In an embodiment of the invention, the monitoring is conducted in real time.

### BRIEF DESCRIPTION OF THE DRAWINGS

The invention will now be described with reference to the accompanying drawings, which illustrate a preferred embodiment of the present invention without restricting the scope of the invention's concept.

FIG. 1 is a block diagram illustrating the components of a pedestrian accommodation system according to an embodiment of the invention;

FIG. 2 is a block diagram illustrating the components of pedestrian accommodation system according to another embodiment of the invention;

FIG. 3 is a block diagram illustrating the components of a mounting structure of the pedestrian accommodation system according to an embodiment of the invention;

FIG. 4 is a block diagram illustrating the kinetic energy tiles in connection with the illumination device and the kiosk according to an embodiment of the invention;

FIG. 5 is a block diagram illustrating storage of energy from a solar power system and from kinetic energy tiles into a battery according to an embodiment of the invention;

FIG. 6 is a block diagram illustrating the components of a kiosk according to an embodiment of the invention;

FIG. 7 is a block diagram illustrating a pedestrian accommodation network according to an embodiment of the invention;

FIG. 8 illustrates a perspective top view of a roof section in the form of a leaf according to an embodiment of the invention;

FIG. 9 illustrates a perspective bottom view of a roof section in the form of a leaf according to an embodiment of the invention;

FIG. 10 illustrates a top view of a roof section in the form of a leaf according to an embodiment of the invention;

FIG. 11 illustrates a bottom view of a roof section in the form of a leaf according to an embodiment of the invention;

FIG. 12 illustrates a first side view of a roof section in the form of a leaf according to an embodiment of the invention;

FIG. 13 illustrates a second side view of a roof section in the form of a leaf according to an embodiment of the invention;

FIG. 14 illustrates a back view of a roof section in the form of a leaf according to an embodiment of the invention;

FIG. 15 illustrates a front view of a roof section in the form of a leaf according to an embodiment of the invention;

FIG. 16 illustrates a perspective top view of a roof structure having a foliage like structure with a plurality of roof sections according to an embodiment of the invention;

FIG. 17 illustrates a perspective bottom view of a roof structure having a foliage like structure with a plurality of roof sections according to an embodiment of the invention;

FIG. 18 illustrates a top view of a roof structure having a foliage like structure with a plurality of roof sections according to an embodiment of the invention;

FIG. 19 illustrates a bottom view of a roof structure having a foliage like structure with a plurality of roof sections according to an embodiment of the invention;

FIG. 20 illustrates a first side view of a roof structure having a foliage like structure with a plurality of roof sections according to an embodiment of the invention;

FIG. 21 illustrates a second side view of a roof structure having a foliage like structure with a plurality of roof sections according to an embodiment of the invention;

FIG. 22 illustrates a third side view of a roof structure having a foliage like structure with a plurality of roof sections according to an embodiment of the invention;

FIG. 23 illustrates a fourth side view of a roof structure having a foliage like structure with a plurality of roof sections according to an embodiment of the invention;

FIG. 24 illustrates a perspective top view of a pedestrian accommodation system comprising a roof structure and a kiosk according to an embodiment of the invention;

FIG. 25 illustrates a perspective bottom view of a pedestrian accommodation system comprising a roof structure and a kiosk according to an embodiment of the invention;

FIG. 26 illustrates a top view of a pedestrian accommodation system comprising a roof structure and a kiosk according to an embodiment of the invention;

FIG. 27 illustrates a bottom view of a pedestrian accommodation system comprising a roof structure and a kiosk according to an embodiment of the invention;

FIG. 28 illustrates a first side view of a pedestrian accommodation system comprising a roof structure and a kiosk according to an embodiment of the invention;

FIG. 29 illustrates a second side view of a pedestrian accommodation system comprising a roof structure and a kiosk according to an embodiment of the invention;

FIG. 30 illustrates a first side perspective view of a pedestrian accommodation system comprising a roof structure and a kiosk according to an embodiment of the invention; and

FIG. 31 illustrates a second side perspective view of a pedestrian accommodation system comprising a roof structure and a kiosk according to an embodiment of the invention.

### DETAILED DESCRIPTION OF THE INVENTION

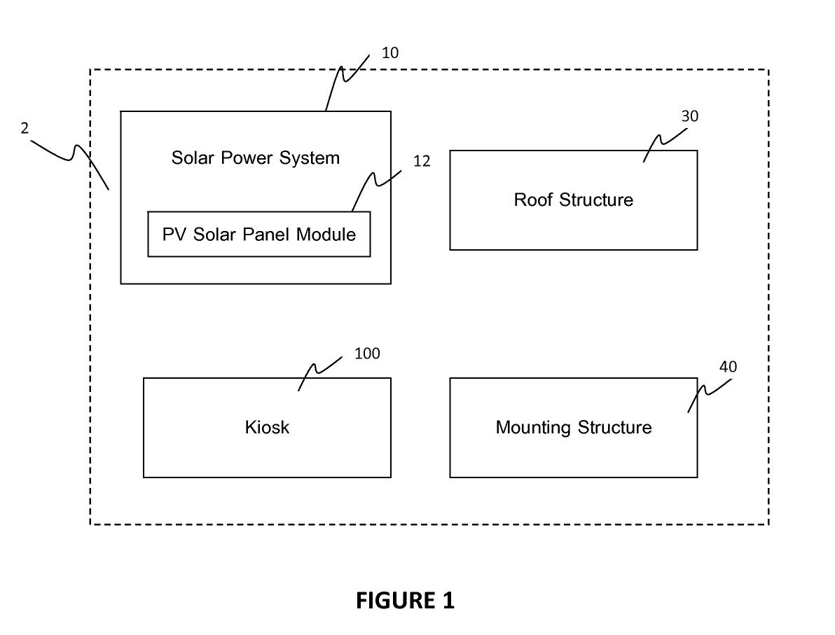

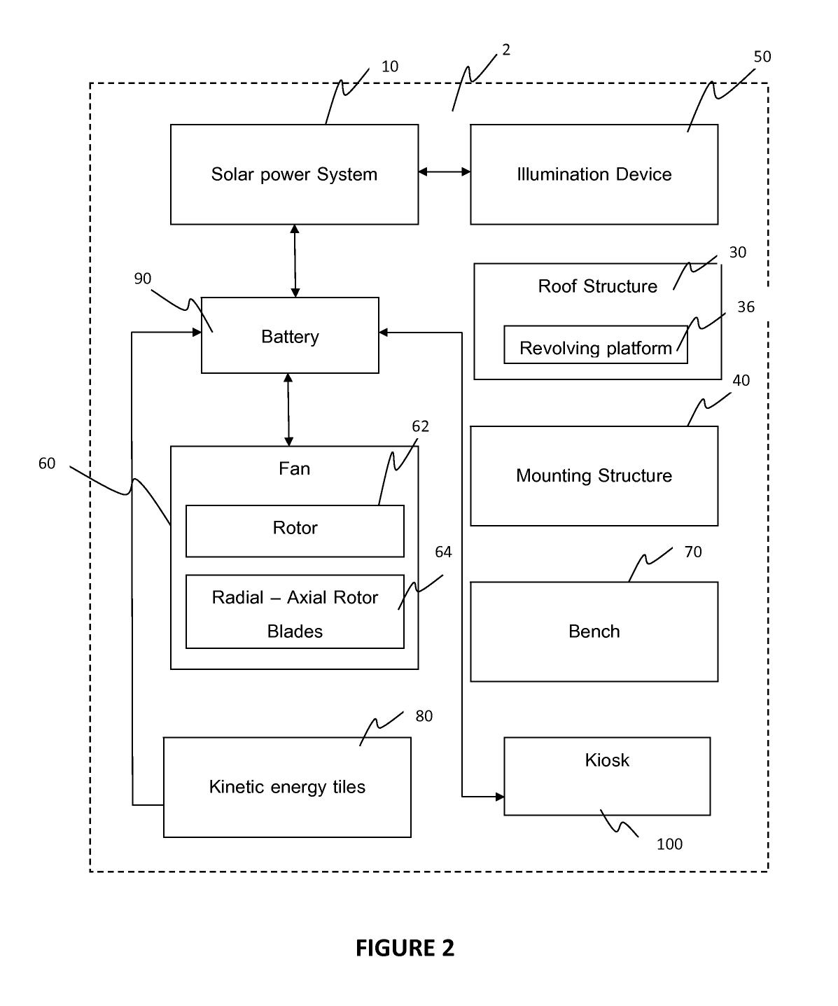

As a first aspect of the invention, as illustrated in FIGS. 1-2, there is provided a pedestrian accommodation system 2 comprising a solar power system 10 comprising a at least one photovoltaic solar panel module 12, a roof structure 30 adapted to receive the at least one photovoltaic solar panel module 12, a mounting structure 40 adapted to support the roof structure 30 to the ground and an electronic kiosk 100 adapted to be electrically coupled to the solar power system 10 and to be located under the roof structure 30. While the preferred description will describe one pedestrian accommodation system 2, in another embodiment, a plurality of such pedestrian accommodation systems 2 are provided in different locations and are linked through a central processing unit/computer terminal (not shown).

The solar power system 30 is a photovoltaic solar system adapted to capture sun/light from the environment for conversion into electricity. The at least one photovoltaic solar panel module 12 is preferably a plurality of PV modules 12 adapted to be part of the roof structure 30. The plurality of PV modules 12 are interconnected for forming an array of PV modules 12. The PV modules 12 are adapted to form a roof top of the roof structure 30. The PV modules 12 are adapted in dimensions to fit within the roof structure 30 and/or the roof structure 30 is adapted in shape to receive the PV modules 12.

The roof structure 30 is adapted to securely receive the PV modules 12 according to a suitable angle to maximize solar/light capturing for conversion into electricity. The roof structure 30 is preferably adjustable in 3 dimensions (x-y-z plans) in the sense that it can be adjusted in such a manner to have the PV modules 12 face the sun in a suitable angle for maximizing light capturing and therefore energy generation. The adjustability of the roof structure 30 also serves for the purposes of sheltering the kiosk 100 users from the sun. The roof structure 30 preferably comprises a revolving platform 36 adapted to revolve the roof structure 30 in three dimensions.

The roof structure 30 is adapted to form a shelter zone 34 protecting users from rain or sunlight while using the kiosk 100. The roof structure 30 can therefore be adjusted in position to form a shelter zone for kiosk 100 users. The roof structure 30 can be adjusted using the revolving platform 36 in such a manner for the PV modules 12 face the sun. This same positioning is normally the suitable position to form a shelter zone 34 for users of the kiosk 100 from the sun. Therefore, the adjustment of the roof structure 30 serves a dual goal, first for light/sun capturing maximization and second for shelter forming for users of the kiosk 100.

In an embodiment of the invention, the revolving platform 36 is also rotatable about the vertical axis of the mounting structure 40 for forming a fan 60. In this case, the roof sections 32 are adapted to form the blades 64 of the fan 60. The revolving platform 36 comprises in this case a rotor 62 adapted to rotate about the vertical axis of the mounting structure 40. The roof sections 32 are in this case adapted to be connected to the rotor 62 and the roof sections 32 form in this case the radial-axial rotor blades 64 adapted to rotate using the rotor 62.

The solar power system 10 is adapted to be connected to the kiosk 100 for providing electrical energy for the operation of the electronic/electrical components of the kiosk 100. The solar power system 10 is preferably connected to a battery 90 for storing the electrical energy generated. The battery 90 can be in turn connected to the kiosk 100 for providing the required electrical energy for its operation.

The pedestrian accommodation system 2 further comprises an illumination device 50 electrically connected to the solar power system 10. The illumination device 50 is adapted to project light within the shelter zone 34. The illumination device 50 may include LED devices or other types of electrical lighting fixtures. The illumination device 50 is adapted to be located at the roof structure 30 in such a manner to project light downwardly towards the ground. In this sense, the PV modules 12 would form the roof top side of the roof structure 30 and the illumination device 50 is located at the bottom side of the roof structure 30.

The roof structure 30 is adapted to receive the illumination device 50 and comprises openings at its bottom side for receiving the lighting fixtures and allowing the passage of light. The illumination device 50 can also be connected to the battery 90 for using the electrical energy stored for operation. The illumination device is preferably adapted to be operated by a user using the kiosk 100 and/or preconfigured to operate at a specific time (at night for example) using a processing unit/computer terminal (not shown). Preferably, the illumination device 50 is connected to the computer terminal 106 of the kiosk 100 for enabling its pre-configuration and/or operation by a user and/or automatically using a computer program running at the computer terminal 106.

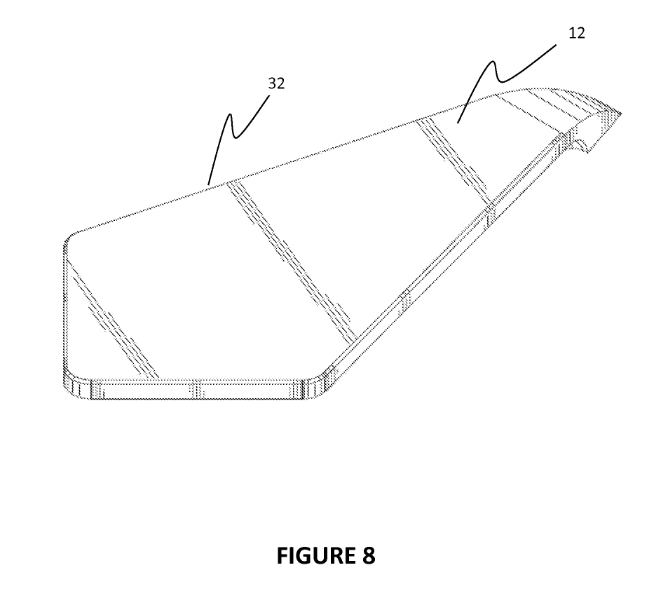

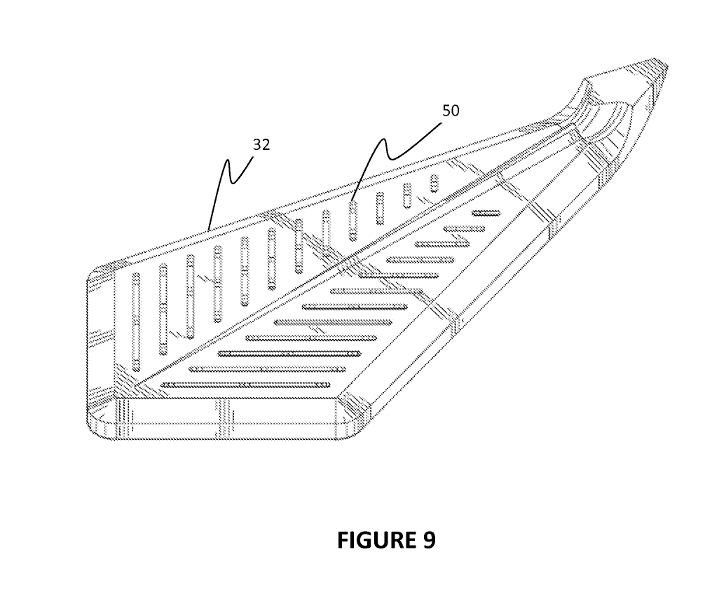

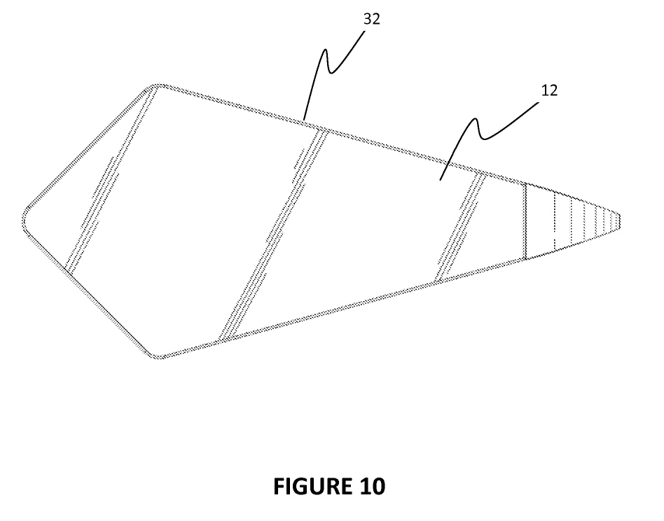

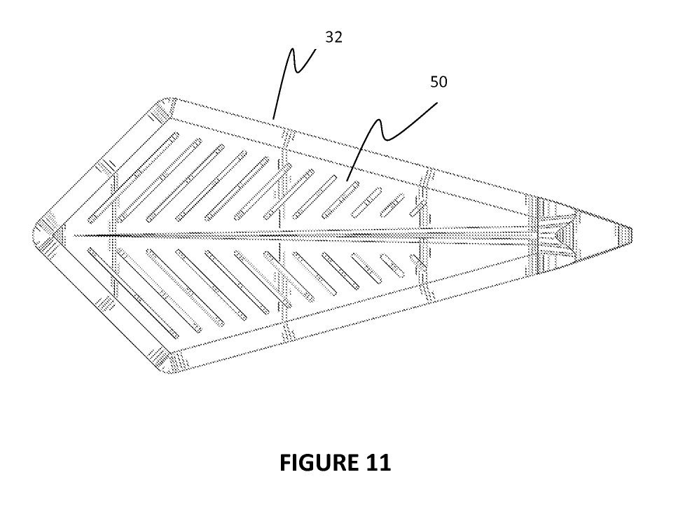

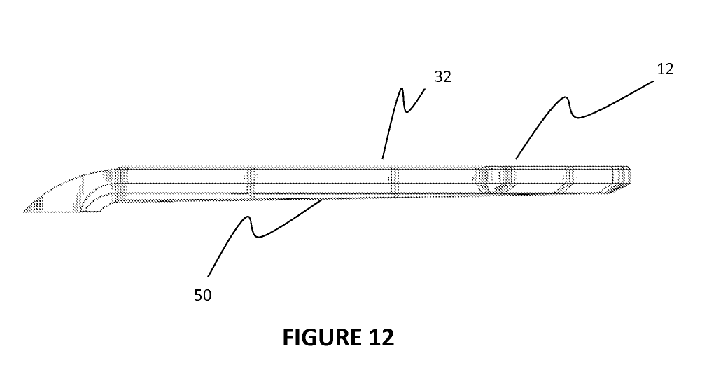

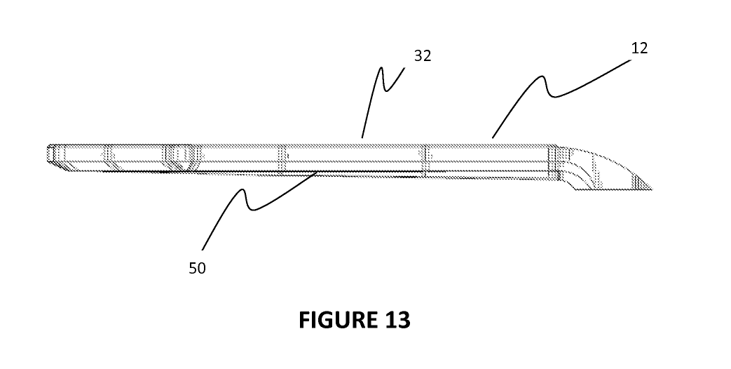

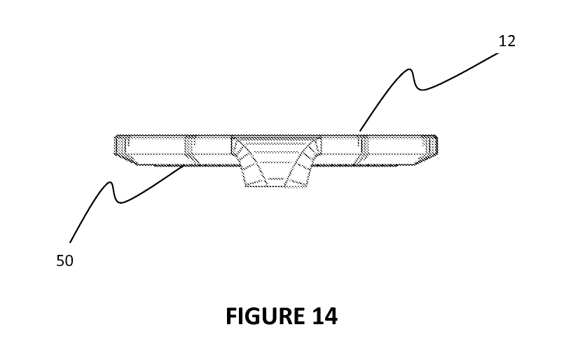

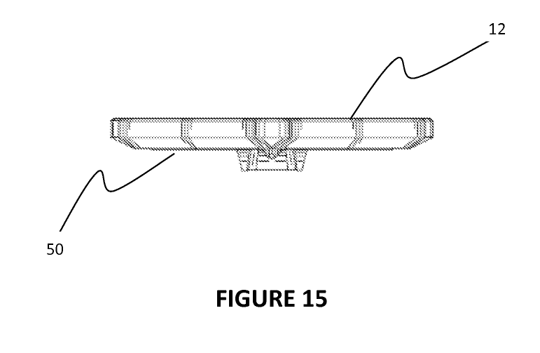

Preferably, the roof structure 30 comprises a plurality of roof sections 32 which are adapted to be assembled together to form the roof structure 30. As illustrated in FIGS. 8-15, the roof sections 32 preferably have a leaf like structure. Each roof section 32 comprises a PV panel/module 12 at one side (top side) and lighting fixtures/openings part of the illumination device 50 at the opposite side (bottom side). The PV modules 12 are adapted to be oriented upwardly towards the sky for exposure to the sun. The lighting fixtures/openings of the illumination device 50 are adapted to be oriented downwardly for projecting light in the direction of the ground within the shelter zone 34. Preferably, these lighting fixtures/openings of the illumination device 50 have a structure of leaf lines. The roof sections 32 comprise a housing enclosing the illumination device 50 and the PV modules 12 which can be made of fiber reinforced-plastic, aluminum, metal or any suitable material.

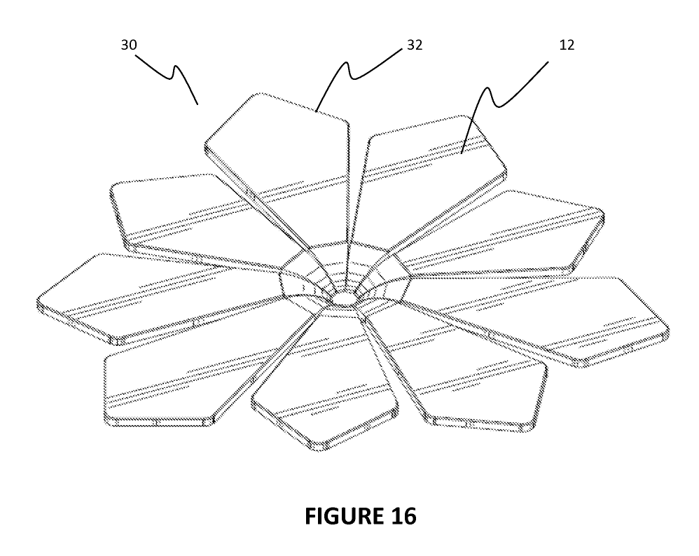

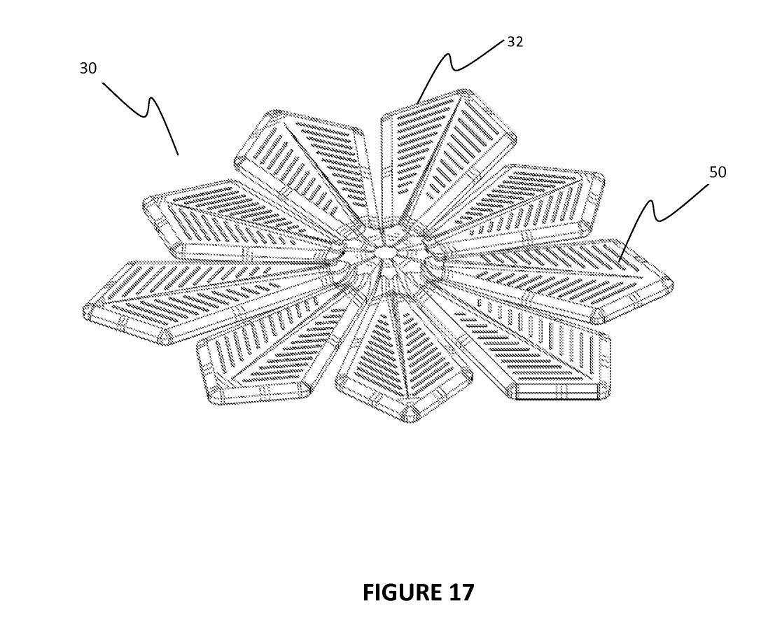

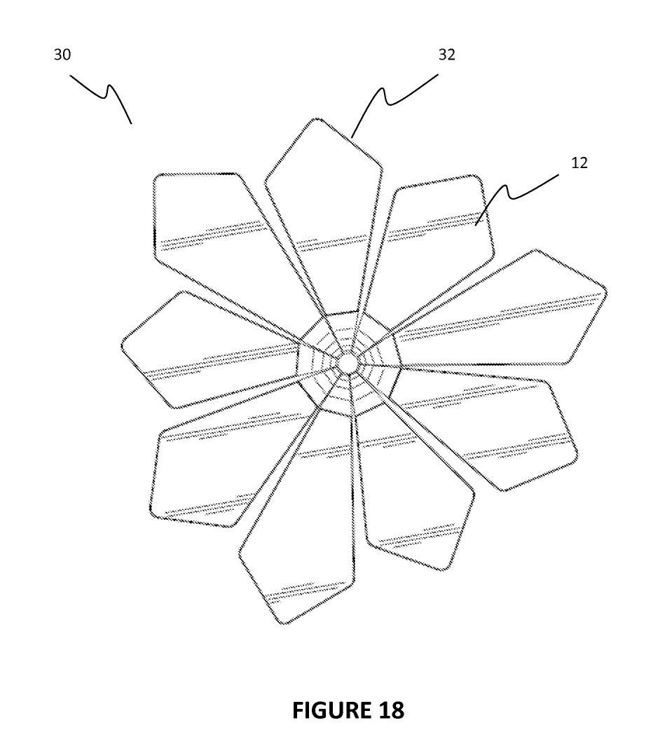

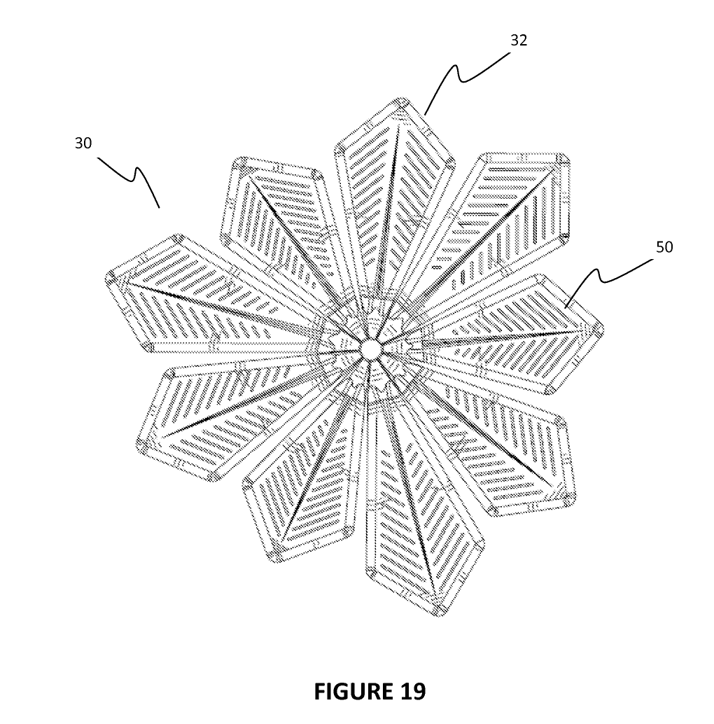

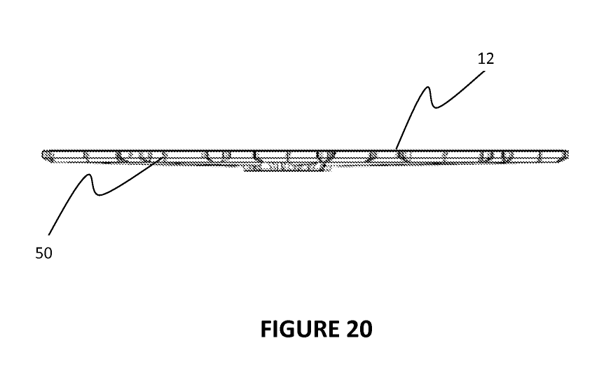

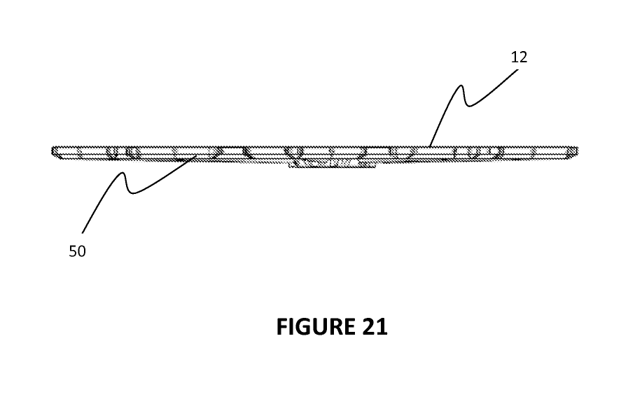

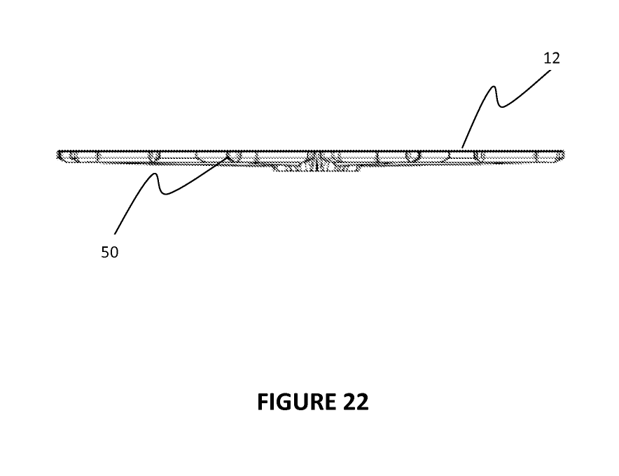

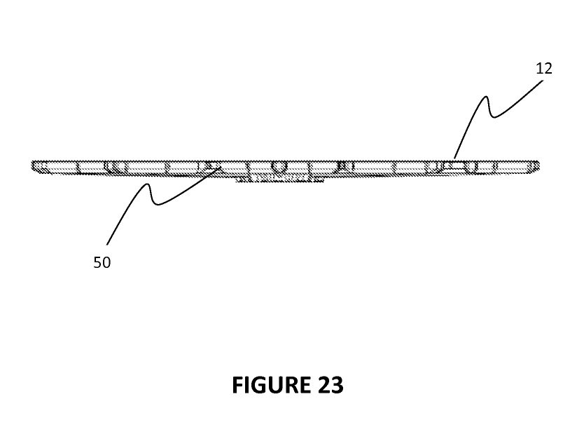

As illustrated in FIGS. 16-23, the roof sections 32 have a leaf like structure and when assembled together, the whole roof structure 30 would have foliage like structure. This type of structure is stable, easily adjustable in position (when connected to the revolving platform 36) and efficient for solar collection and for forming a shelter zone 34 in proximity of the kiosk 100. The zone underneath the roof structure forming the foliage like structure 30 would form the shelter zone 34 for the users of the kiosk 100.

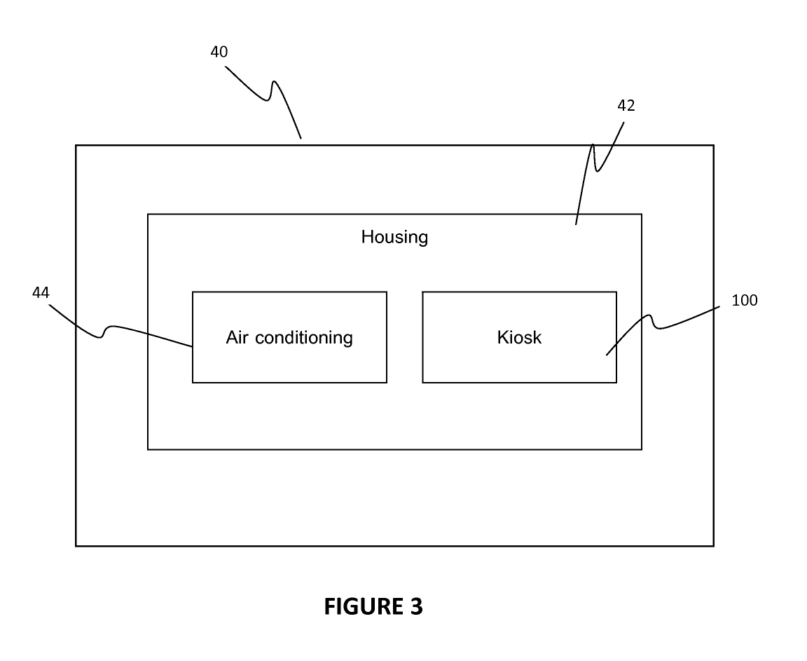

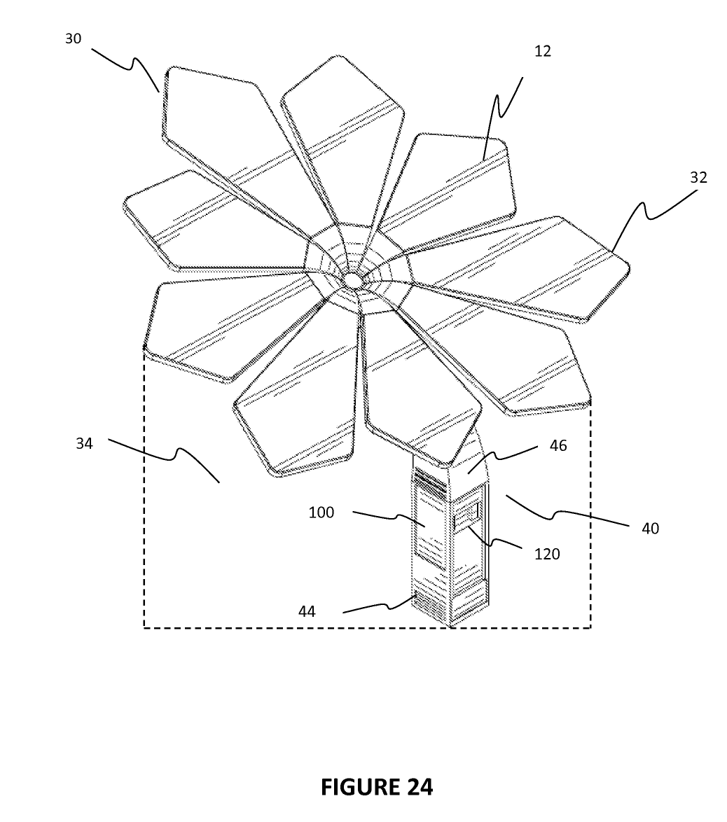

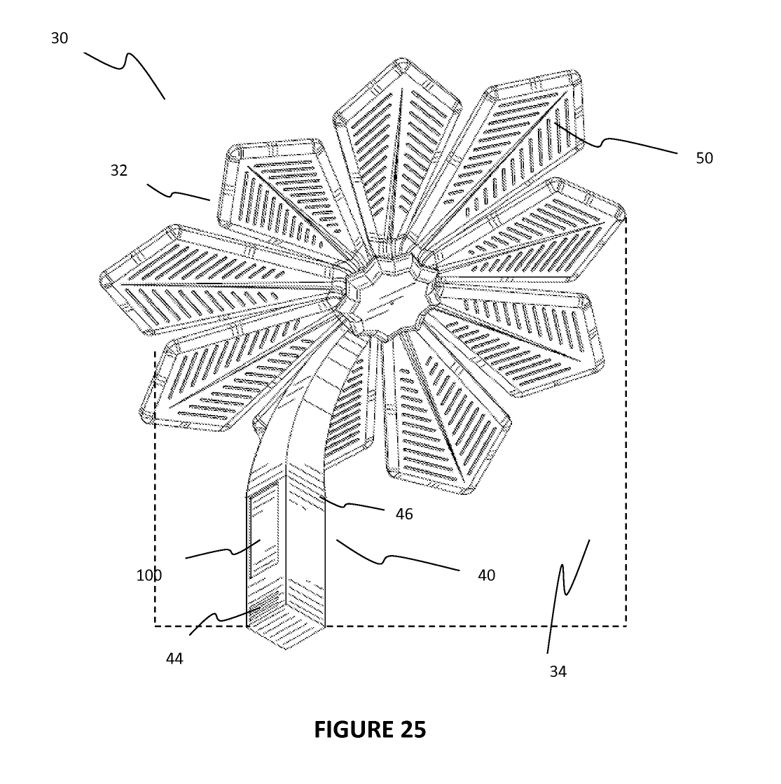

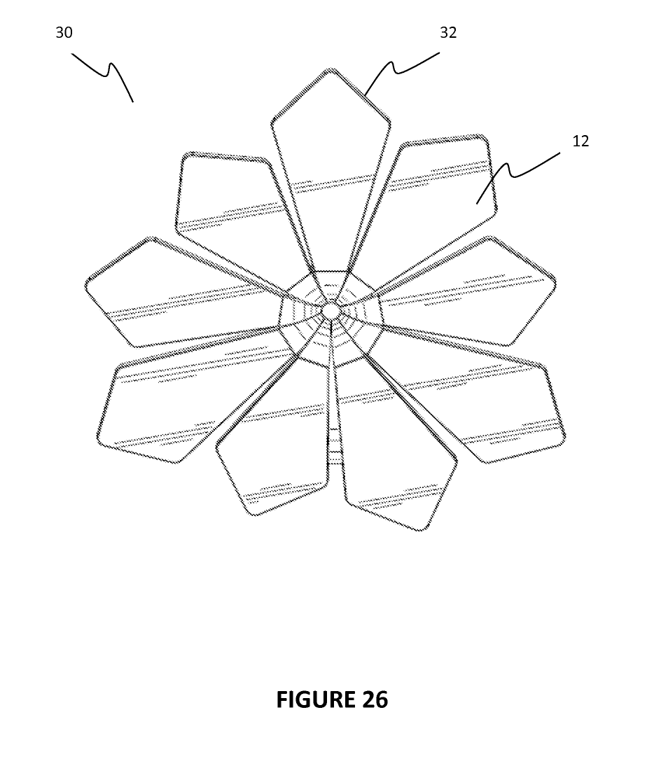

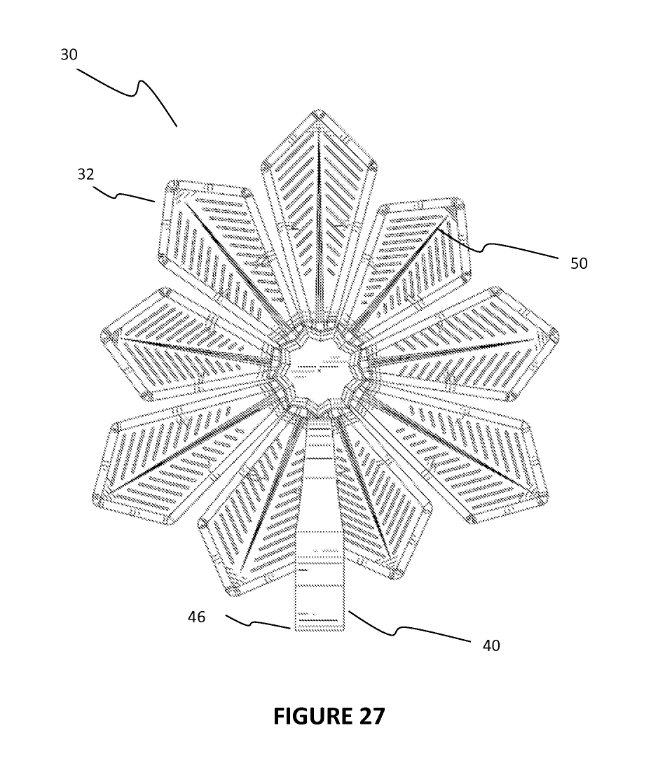

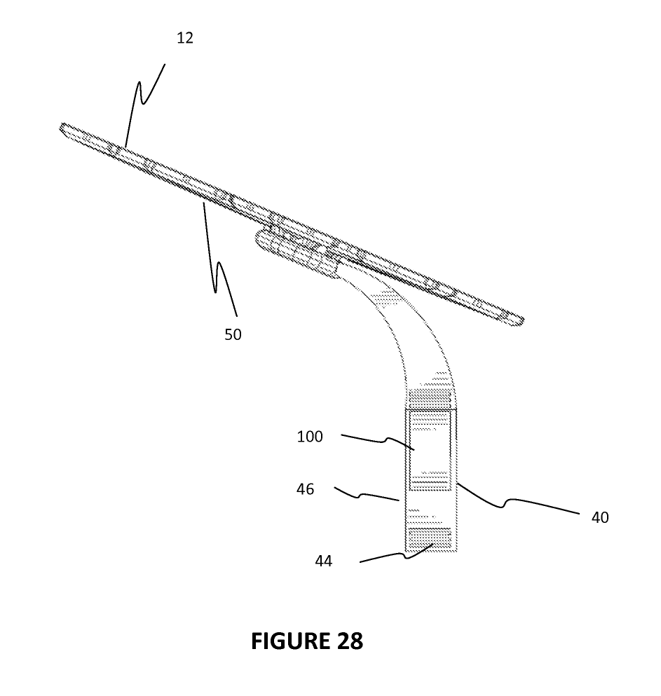

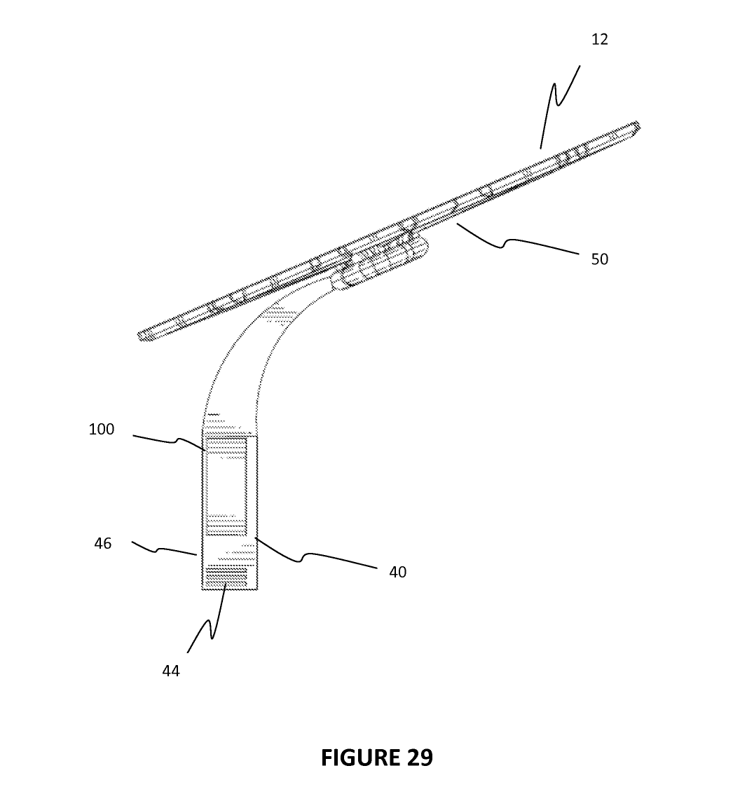

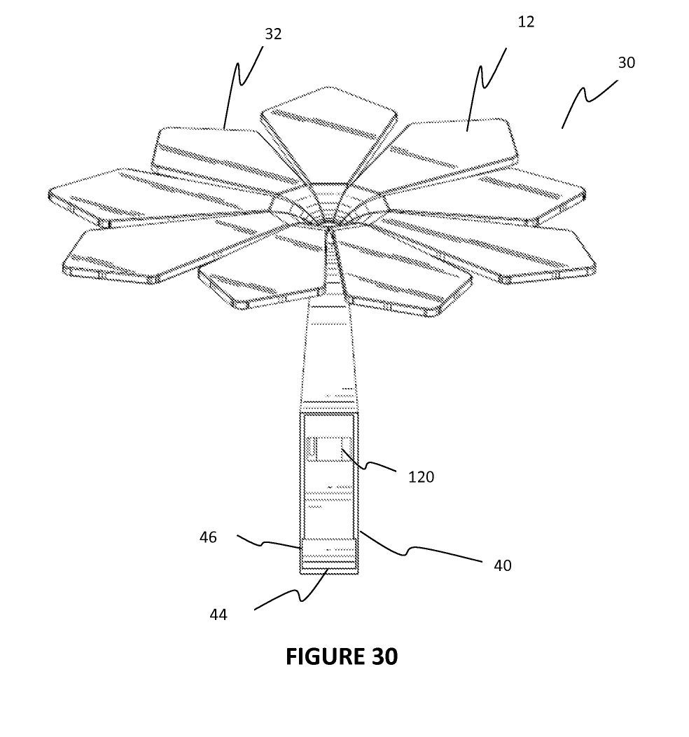

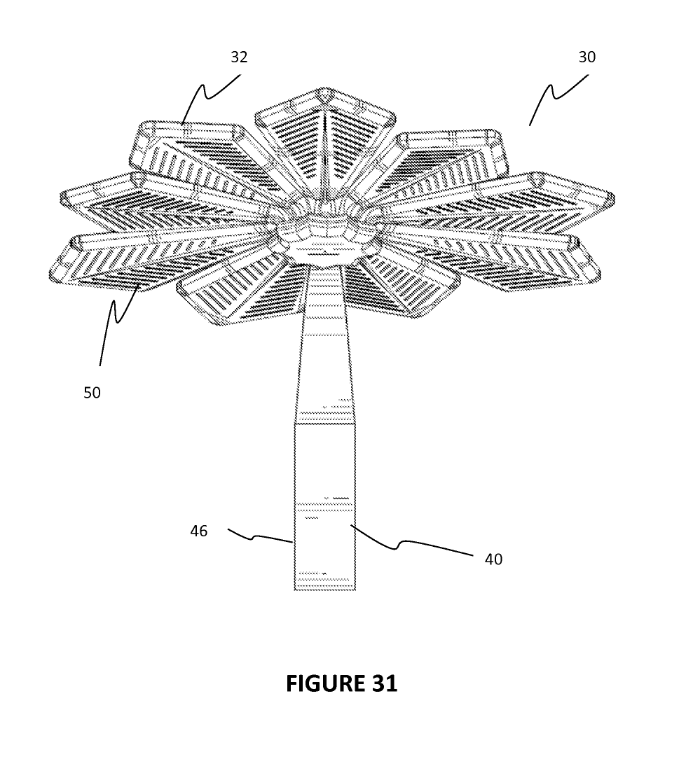

The mounting structure 40 is preferably made of metallic structure or other material of sufficient strength adapted for supporting the roof structure 30. As illustrated in FIG. 3 and FIGS. 24-31, the mounting structure 40 comprises a lower end adapted to be connected to the ground, a housing 42 adapted to receive the kiosk 100 and an upper end adapted to be connected to the roof structure 30. The housing 42 is adapted to enclose the kiosk 100 and, optionally, an air conditioning unit 44 adapted to spread cool air within the shelter zone 34. The housing 42 also comprises openings for providing user access to the displays 102 & 104 of the kiosk 100. The mounting structure 40 is preferably in the form of a tree stem. The pedestrian accommodation system 2 further comprises at least one bench 70 adapted to be located under the roof structure 30 in proximity of the mounting structure 40 within the shelter zone 34. Preferably, the bench 70 is adapted to be positioned in such a manner to provide user access to the displays 102,104 while sitting on the bench 70.

Preferably, the roof structure 30 is in the form of foliage, the mounting structure 40 is in the form of a stem 46 and the combination of the roof structure 30 and the mounting structure 40 is in the form of a palm tree.

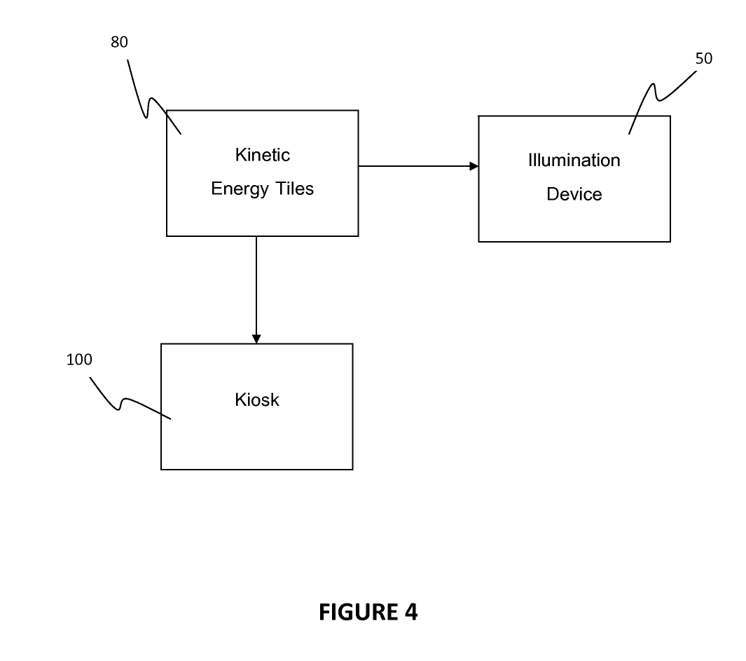

As illustrated in FIG. 4, in an embodiment of the invention, the pedestrian accommodation system 2 further comprises energy generating floor tiles 80 for transforming pedestrian movements into electrical energy, the kinetic energy tiles 80 being adapted to be electrically connected to the electronic kiosk 100 and to the illumination device 50. Preferably, the kinetic energy tiles 80 are located on a pedestrian pass way in proximity of the mounting structure 40, the kinetic energy tiles 80 comprising underground electrical cables adapted to extend between the kinetic energy tiles 80 and the kiosk 100 and/or the illumination device 50.

Optionally, the kinetic energy tiles 80 are adapted to be mounted on pedestrian pass ways and to be connected to the battery 90 for converting kinetic energy generated by pedestrians into electrical energy and for storing said energy inside said battery 90. Optionally, the kinetic energy tiles 80 are adapted to be mounted in proximity of the bench 70.

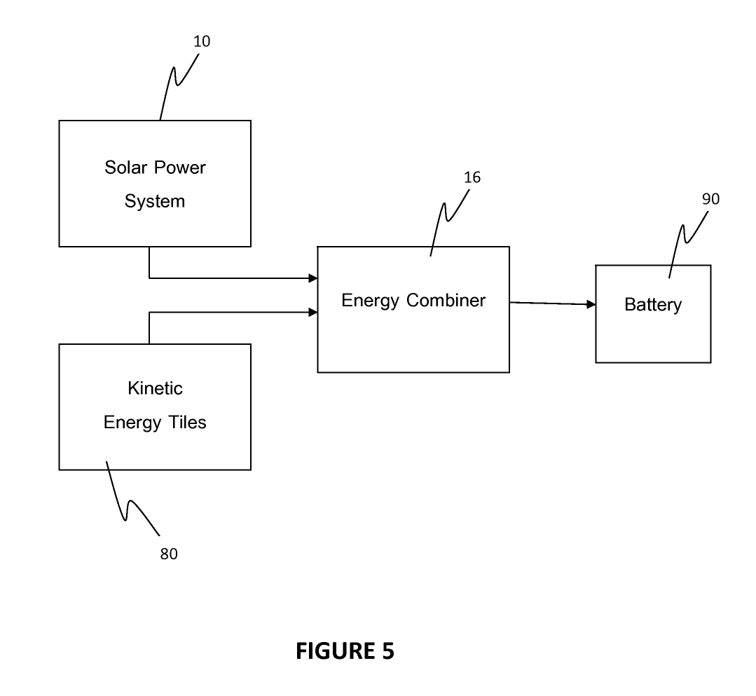

As illustrated in FIG. 5, the pedestrian accommodation system 2 further comprises an energy combiner 16 for combining electrical energy originating from the solar power system 10 and from the kinetic energy tiles 80. The energy combiner 16 is adapted to be connected to the battery 90 for storing the collected energy.

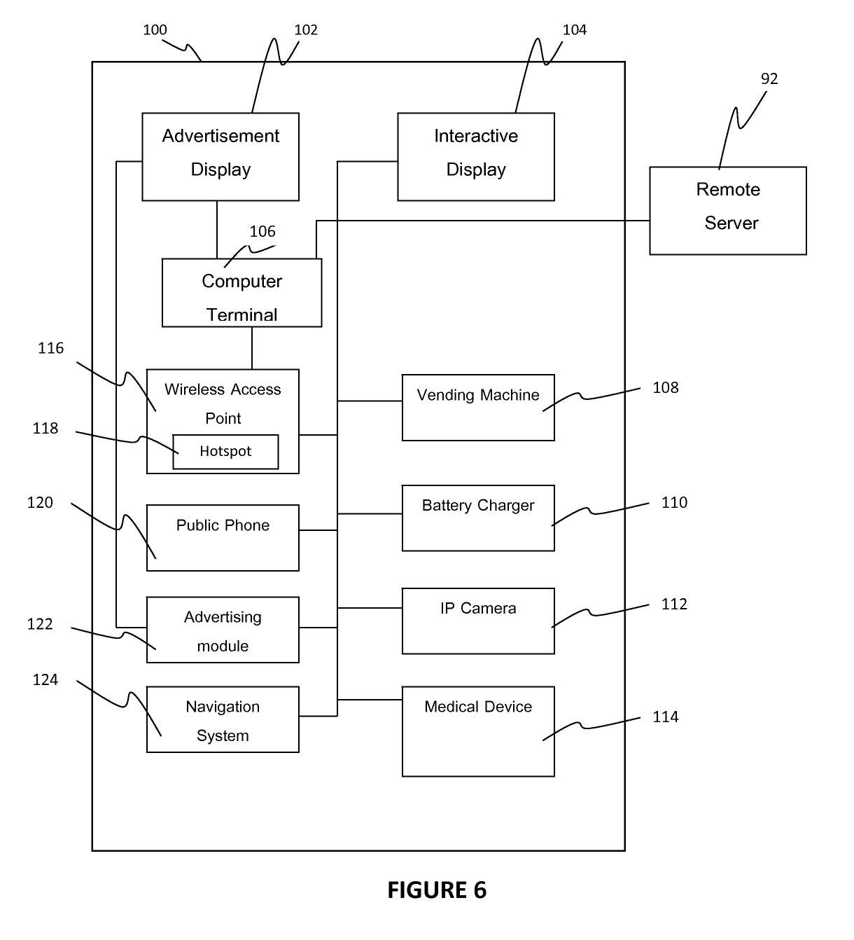

As illustrated in FIG. 6, the electronic kiosk 100 is adapted to provide users access to wide range of services. Said kiosk 100 is a self-service unit which encloses a plurality of displays 102,104, wherein such displays 102,104 are connected to a computer terminal 106. The kiosk 100 comprises a computer terminal 106, an advertisement display 102, an interactive display 104, a wireless access point 116, a public phone 120, advertisement module 122, a navigation system 124, a medical device 114, an IP camera 112, a battery charger 110 and a vending machine 108. The computer terminal 106 is adapted to be connected to all the components of the kiosk 100 for enabling their operation. The computer terminal 106 is preferably adapted to be connected to a remote server 92 via a data network such as a control server managed by an administration authority or a governmental authority.

The computer terminal 106 is adapted to control the functions/services available to users using the kiosk 100. The computer terminal 106 is adapted to be connected to an advertisement module 122 and to the advertisement display 102 for displaying advertisement materials to the users. The advertisement material can be preconfigured inside the advertisement module 122 or dynamically loaded inside the advertisement module 122 passing by the computer terminal 106 through the remote server 92. Preferably, the advertisement module 122 is preconfigured inside the computer terminal 106. The computer terminal 106 is adapted to be connected to the interactive display 104 for enabling users to interact with the computer terminal 106 for access to the different services available.

The computer terminal 106 is adapted to be connected to the wireless access point 116 to activate wireless internet connection for generating a hotspot 118 enabling users within the shelter zone 34 to connect to the Internet. Optionally, the kiosk 100 conducts statistical data analysis such as information about the signal strength, quality and number of WIFI connected users, wherein such statistical data is shared with the user and displayed on said interactive display 104. The kiosk 100 monitors the efficiency of the signal quality and strength, whenever the received signal strength is determined to have changed from one level to another level, said computer terminal 106 is adapted to send a notification message to the remote server 92.

The computer terminal 106 is adapted to be connected to a vending machine 108 to enable its operation. The computer terminal is adapted to provide a digital menu to the users for the different items available in the vending machine 108 and to accept payments from the users using credit cards or other payment means such as bank account transfers, e-commerce available payment means, SMS based transactional payments and online wallets. The computer terminal 106 is adapted to control the vending machine 108 for delivering the paid items to the users.

The computer terminal 106 is adapted to be connected to the phone 120 for enabling users to make phone calls. Such enablement can be granted by the computer terminal 106 after payment is received from the users. Optionally, the phone 120 is adapted to be connected to the Internet for enabling users to make voice-over-IP calls. The phone 120 is adapted to enable users to make private calls, video calls and/or emergency calls.

The computer terminal 106 is adapted to be connected to the navigation system 124 for enabling users to find directions/information with respect to other facilities such as stores and restaurants in proximity of the pedestrian system 2. The navigation system 124 is connected to the advertising module 122 for providing users with directions to advertised locations such as a list of stores and respective contact information located within a predefined geographical zone from the kiosk 100, including city's attractions such as city's events. The navigation system 124 is also adapted to provide user with their current location and with a list of other pedestrian accommodation systems 2 available in predefined geographical zone with respective locations/directions. The navigation system 124 is adapted to support zooming, where the user can zoom in, zoom out or pan through a navigation map. The kiosk 100 is adapted to facilitate access to third party services such as transportation and medical services by connecting with remote stations associated with third parties service providers (by phone or Internet for example), wherein the user's current location is obtained via the navigation system 124 and sent to the remote stations.

The computer terminal 106 is adapted to be connected to the medical device 114 for enabling users to operate/activate the medical device for conducting certain medical tests such as blood pressure, pulse and body fat measurement and alcohol rate. The computer terminal 106 is adapted to display the medical results on the interactive display 104 or to send the information by email or text message at an address specified by the user such as an email address or a mobile device number. Optionally, the medical device 114 is operable after a payment made by the user using the interactive display 104.

The computer terminal 106 is adapted to be connected to an IP camera 112 for enabling users to take pictures, take self-portrait photograph (with city's attractions for example) or record a video stream and transmitting these to a destination they specify using the interactive display 104 such as to their email address. Optionally, the IP camera 112 is operable after a payment made by the user using the interactive display 104. Preferably, said IP camera 112 can be used in emergency cases for enabling users to stream video or make video calls and streaming such videos from the pedestrian accommodation system 2 used to another pedestrian accommodation system 2 in another location and vice versa. The kiosk 100 is adapted to enable users to share such taken photographs and/or streamed videos in internet-based applications which may include the user's social media network account. Users are also enable to download the photographs and/or streamed videos from a website allocated for the pedestrian accommodation system 2.

The computer terminal 106 is adapted to be connected to a battery charger 110 for enabling users to use the battery charger 110 to charge their mobile devices. The computer terminal may allow use of the charger 110 if sufficient energy is stored inside the battery 90. Optionally, the battery charger 110 is activated by the computer terminal 106 after a payment made by the user using the interactive display 104. The housing 42 comprises openings adapted to enable user access to said battery chargers 110. The battery chargers 110 are adapted to use the accumulated energy inside the battery 90 for charging purposes, wherein said battery chargers 110 are also adapted to charge golf carts.

The computer terminal 106 is adapted to be connected to the Internet for providing users browsing facilities of the Internet. Optionally, the browsing facility is activated by the computer terminal 106 after a payment made by the user using the interactive display 104.

The computer terminal 106 is adapted to provide a secured environment to users to avoid piracy of information between the different users, such as hiding the system drivers, providing password protection features, hiding the user accounts, deleting browser data while switching between users, and disabling internal file downloads.

Optionally, the kiosk 100 comprises a microphone (not shown) for allowing user interaction with the interactive display 104 via voice, and the computer terminal 106 is adapted to receive instructions from users in multiple languages. Optionally, the interactive display 104 is a touch screen. The kiosk 100 is adapted to provide information of public interest to users through one of the displays 102 and 104 such as for example the current time, temperature, humidity and sea water temperature, exchange rate information, local news, information about public services, emergency services, social services, health care and the like.

The kiosk 100 is adapted to be in communication with the remote server 92 for reporting any technical issue with the kiosk 100 such as whenever the displays 102,104 are inoperative.

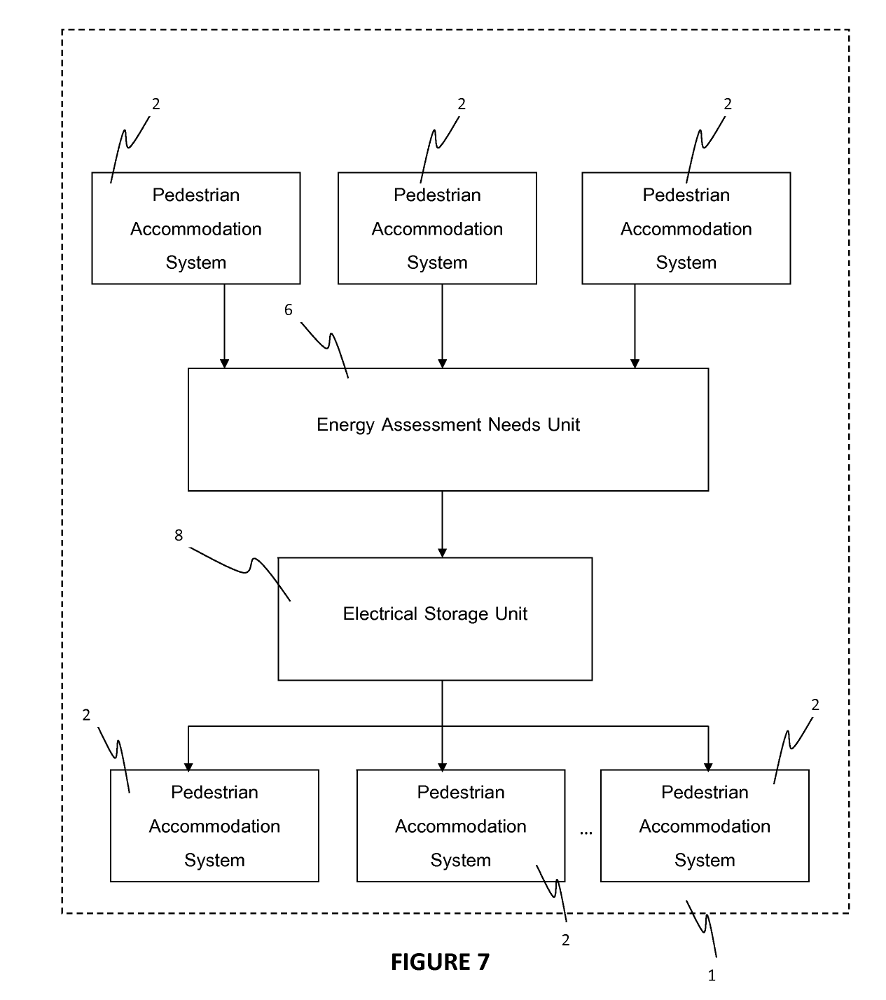

As illustrated in FIG. 7, as a further aspect of the invention, there is provided a network 1 comprising a plurality of pedestrian accommodation systems 2, an energy assessment needs unit 6 and an electrical storage unit 8. The energy assessment unit 6 is adapted to be connected to the plurality of pedestrian accommodation systems 2 and is adapted to assess the energy needs of each one of the plurality of pedestrian accommodation systems 2 and to instruct the electrical storage unit 8 to distribute energy to the accommodations systems 2 dynamically based on the needs. The electrical storage unit 8 can be a battery for example. The electrical storage unit 8 is adapted to be connected to the pedestrian accommodation systems 2 for receiving and storing the energy generated by their respective solar power systems 10 and kinetic energy tiles 80. Preferably, the energy consumption assessment needs is monitored and determined in real time. The pedestrian accommodation systems 2 are also adapted to speak and share information between each other.

In an embodiment of the invention, the kiosks 100 associated with the accommodations systems 2 of the network 1 are adapted to enable users to indicate the names of reported lost persons they are looking for in case they lost contact with the person (such as a child) and to indicate the name of the reporting person (such as themselves). The systems 2 are adapted to automatically display the location of the reporting person and the systems 2 are adapted to share this information between them to display a list of the reporting and reported persons on the respective displays 102 or 104 of each one of the other kiosks 100 of the network 1. The reported lost persons can monitor these lists and identify the location of the reporting persons on the display 102 or 104 and use the interactive display 104 to contact those reporting persons using the kiosk 100 facilities such as the phone 120 and to get directions to reach these persons using the navigation system 124.

Although the above description of the present invention has disclosed the features of the invention as applied to the preferred embodiment; additions, omissions and modifications applied to the details of the embodiment illustrated may be made by those skilled in the art without departing from the essential characteristic of the present invention.

Although the invention has been explained in relation to its preferred embodiment, it is to be understood that many other possible modifications and variations can be made without departing from the spirit and scope of the invention as herein described.

1. A pedestrian accommodation system comprising:
a solar power system comprising at least one photovoltaic solar panel module;
a roof structure adapted to receive said at least one photovoltaic solar panel module
a mounting structure adapted to support the roof structure to the ground;
an electronic kiosk adapted to be electrically coupled to said solar power system and to be located under the roof structure;
wherein said the roof structure is adapted to form a shelter zone protecting users from rain or sunlight while using the kiosk.

2. The system as claimed in claim 1 further comprising:
an illumination device electrically coupled to said solar power system, the illumination device being adapted to project light within the shelter zone, the illumination device being adapted to be located within the roof structure.

3. The system as claimed in claim 2 wherein said roof structure comprises a plurality of roof sections each one having a leaf like structure, and wherein the at least one photovoltaic solar panel module comprises a plurality of photovoltaic solar panel modules each one having a leaf like structure, said plurality of photovoltaic solar panel modules forming said plurality of roof sections.

4. The system as claimed in claim 3 wherein said photovoltaic solar panel modules form a top portion of the roof structure adapted to be directed upwardly for exposure to the sun, and wherein the illumination device form a bottom portion of the roof structure adapted to provide light downwardly towards the ground for users within the shelter zone.

5. The system as claimed in claim 4 further comprising a fan comprising a rotor and radial-axial rotor blades adapted to be located within the roof structure and to be electrically connected to the solar power system, wherein the roof sections are adapted to be in a blade like structure forming said radial-axial rotor blades.

6. The system as claimed in claim 1 wherein the mounting structure comprises a housing adapted to house said electronic kiosk, the electronic kiosk comprising a computer terminal and at least one of an interactive display enabling user access to electronic services and an advertisement display.

7. The system as claimed in claim 6 wherein the electronic kiosk comprises battery chargers for enabling users to charge their mobile devices, and wherein said housing comprising openings adapted to enable user access to said battery chargers.

8. The system as claimed in claim 7 further comprising a bench adapted to be located under the roof structure within the shelter zone, wherein said bench is adapted to be positioned in such a manner to provide user access to the display while sitting on the bench.

9. The system as claimed in claim 1 further comprising energy generating floor tiles for transforming pedestrian movements into electrical energy, the energy tiles being adapted to be electrically connected to the electronic kiosk and to the illumination device.

10. The system as claimed in claim 9 wherein the energy tiles are located on a pedestrian pass way in proximity of the mounting structure, the energy tiles comprising underground electrical cables adapted to extend between the energy tiles and the kiosk.

11. The system as claimed in claim 10 further comprising an electrical combiner for combining electrical energy originating from the solar system and the energy tiles and a battery for storing the electrical energy generated using the solar system and the energy tiles

12. The system as claimed in claim 1 wherein the roof structure is in the form of foliage, the support structure is in the form of a stem and the combination of the roof structure and the support structure is in the form of a palm tree.

13. The system as claimed in claim 1 wherein said kiosk further comprises at least one of:
a wireless access point adapted to generate a hotspot within the shelter zone to enable users to connect to the Internet using their mobile devices within said zone;
a public phone for enabling users to perform private calls, video calls and/or emergency calls using the accumulated energy via IP or land line;
information about a list of stores and respective contact information located within a predefined geographical zone from the kiosk;
a navigation system adapted to orient the users towards a desired location within a predefined geographical zone from the kiosk;
a vending machine operationally coupled to said kiosk for enabling users to order items available at said vending machine;
an IP camera operationally coupled to said kiosk for enabling users to use the IP camera for taking pictures and/or video streaming; and
a medical device operationally coupled to said kiosk for enabling users to perform basic medical measurements comprising at least one of a pressure, pulse and body fat measurement.

14. The system as claimed in claim 13 wherein said kiosk comprises a computer terminal adapted to be connected to a remote server via a data network, wherein the remote server is adapted to remotely access, configure and operate the kiosk through the computer terminal.

15. The system as claimed in claim 14 wherein the remote server is part of a control center.

16. A pedestrian accommodation network comprising:
a plurality of pedestrian accommodation systems as claimed in claim 1;
energy storage device comprising at least one battery adapted to be connected to the plurality of pedestrian accommodation systems for storing energy generated by their respective solar power systems;
an electrical distribution system adapted to be connected to the plurality of pedestrian accommodation systems for monitoring energy consumption needs thereof and for distributing electrical energy thereto from the at least one battery based on said needs.

17. The network of claim 16 further comprising:
energy tiles adapted to be mounted on pedestrian pass ways and to be connected to the energy storage device for converting kinetic energy generated by pedestrians into electrical energy and for storing said energy inside said at least one battery.

18. The network of claim 17 wherein said monitoring is conducted in real time.

19. The network of claim 18 wherein the plurality of pedestrian accommodation systems are adapted to share information therebetween and to display the shared information to users through displays available at said pedestrian accommodation systems.

20. The network of claim 19 wherein said shared information is an identity of a reported lost person an identity and location of a reporting person.
